(19) United States
(12) Patent Application Publication
(10) Pub. No.: US 2005/0265026 A1
(43) Pub. Date: Dec. 1, 2005

(54) Balloon bulb

(75) Inventor: Shu-Lien Tang, Taipei (TW)

Correspondence Address: BACON & THOMAS, PLLC, 625 SLATERS LANE, FOURTH FLOOR, ALEXANDRIA, VA, 22314, US

(73) Assignee: Shu-Lien Tang, Shijr City (TW)

(21) Appl. No.: 10/843,342

(22) Filed: May 12, 2004

(30) Foreign Application Priority Data
May 7, 2004 (TW) 093205945

(51) Int. Cl. F21V 33/00

(52) U.S. Cl. 362/253

(57) ABSTRACT

The present invention provides a balloon bulb design, which includes a LED disposed at an end of a cylinder, and then inserts the cylinder in the mouth of a balloon and tightens the junction between the mouth of the balloon and the cylinder. Another end of the cylinder, via which, the user can blow the balloon up, so as to create a balloon bulb. The cylinder is equipped with battery and provided with a knob at the bottom thereof. When rotating the knob to make the battery contact the LED, the LED will light. Thus, the balloon can emit colorful lights and it will be very nice looking at night.

### BACKGROUND OF THE INVENTION

1. Field of the Invention

The present invention relates to a balloon bulb, and more particularly to a device that is able to dispose a LED in a balloon and make it light.

2. Description of the Prior Arts

Conventional balloon has different colors, which can be used for decoration by creating happy atmosphere in a banquet or party. However, it is short of perfection in an outdoor party at night that the balloon doesn't have any happy effect because it cannot light.

So far, balloon that can light cannot be found in current market. Thus, this is the motivation of the inventor of the present invention to invent a balloon bulb.

### SUMMARY OF THE INVENTION

The primary object in accordance with the present invention is to provide a balloon bulb, which includes a LED disposed at an end of a cylinder, and then inserts the cylinder in the mouth of a balloon and tightens the junction between the mouth of the balloon and the cylinder. Another end of the cylinder, via which, the user can blow the balloon up, so as to create a balloon bulb. The cylinder is equipped with battery and provided with a knob at the bottom thereof. When rotating the knob to make the battery contact the LED, the LED will light. Thus, the balloon can emit colorful lights and it will be very nice looking at night.

The present invention will become more obvious from the following description when taken in connection with the accompanying drawing, which shows, for purpose of illustration only, a preferred embodiment in accordance with the present invention.

### BRIEF DESCRIPTION OF THE DRAWINGS

FIG. 1 is a cross sectional view of a balloon bulb in accordance with the present invention;

FIG. 2 is an operational view of the balloon bulb in accordance with the present invention.

### DETAILED DESCRIPTION OF THE PREFERRED EMBODIMENT

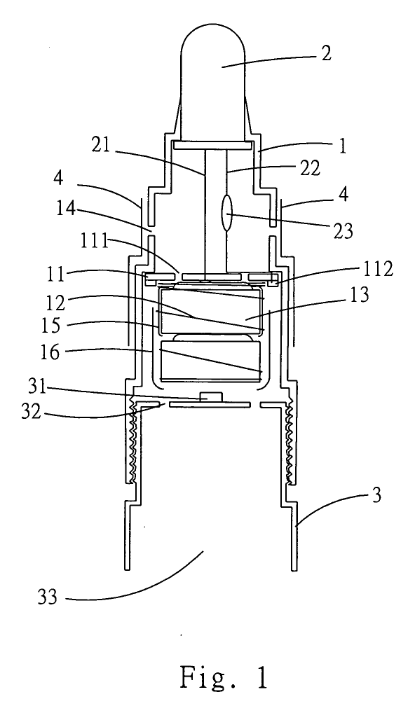

Referring to FIG. 1, a balloon bulb in accordance with one aspect of the present invention includes a small cylinder 1, in a top surface of which is inserted a LED (light emitting diode) 2, a lower portion of the cylinder 1 is hollow and an inner periphery of which is formed with threads for meshing with a knob 3.

The middle inner space of the cylinder 1 is partitioned into a lower space and an upper space by a spacer 11 (printed circuit board). The upper space serves to receive a negative and a positive terminal of the LED 2. The negative terminal 21 is inserted through the spacer 11 so as to be connected to negative pole of a battery below the spacer 11, while the positive terminal 22 is connected with a resistor 23, after that, it is connected to a metal ring 112 (or a metal circuit in a printed circuit board) after inserting through the spacer 11.

An upper and a lower battery 13 are disposed below the spacer 11. The upper battery is wrapped with a thermoplastic sleeve 15 and then a metal spring 12 is used to wrap the two batteries, and finally they are wrapped by another thermoplastic sleeve 16 again. The metal spring 12 uses a lower end to wind around the metal housing (positive pole) of the lower battery, and an upper end of the spring 12 can contact the metal ring 112. By such arrangements, the positive terminal 22 can contact the positive pole of the lower battery.

The knob 3 is provided at the top surface with a protrusion 31. When rotating the knob 3, the protrusion 31 will push the lower battery upward, so as to make the negative pole of the upper battery abut closely against the negative terminal 21 and make the upper end of the metal spring 12 abut closely against the metal ring 112. Thus, the LED will light. If the knob 3 is loosened, the elastic force of the metal spring 12 will enforce the negative pole of the upper battery to disconnect from the negative terminal 21, such that the LED will not light.

The cylinder 1 above the spacer 11 is formed on the sidewall with plural apertures 14, the spacer 11 is formed with plural apertures 111, and the knob 3 is also formed at the top surface with plural apertures 32. When the user blows through a lower hollow space 33 of the knob 3 with his mouth, the air will be blown out through the apertures 32, 111, 14.

An outer peripheral surface of the cylinder 1 is covered with a layer of elastic rubber skin 4 which closely cover the apertures 14 when the user does not blow. When the user blows through the knob 3, the air will be blown out through the apertures 32, 111, 14 and pushes the elastic rubber skin 4 open to leak air.

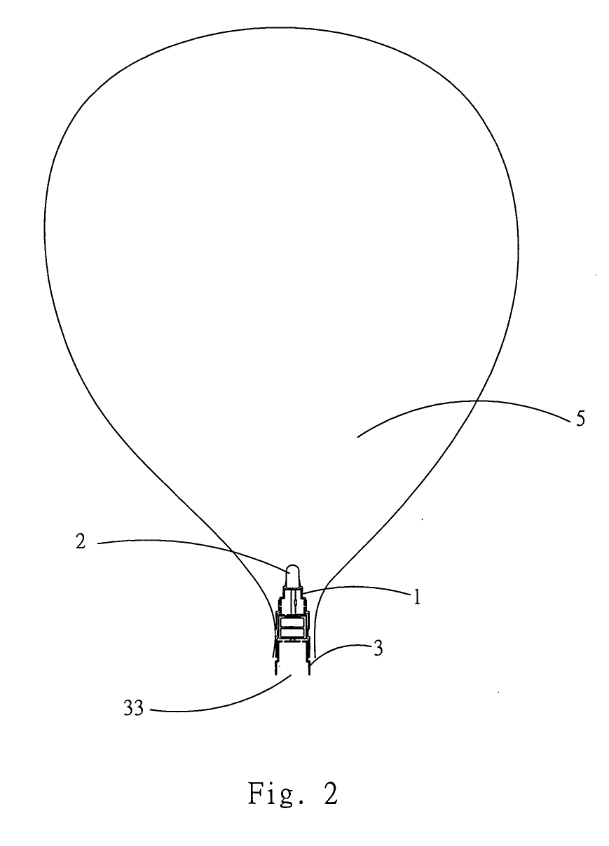

As shown in FIG. 2, after stretching the mouth of a balloon 5 over the cylinder 1 and tightening the junction between the cylinder and the mouth of the balloon with elastic rubber thread, the user blows through the lower hollow space 33 of the knob 3 with his mouth, the air is blown out via the apertures 32, 111, 14 and pushes the elastic rubber skin 4 open, thus the balloon 5 is inflated. After the balloon 5 is inflated to a certain extent, the user stops blowing, and the elastic rubber skin 4 tightly covers the apertures 14 again so as to prevent air leaking from the balloon 5. Through this way, the balloon bulb in accordance with the present invention is formed.

On the other hand, the apertures 32, 111, 14 and the elastic rubber skin 4 also can be omitted. The user can inserts the cylinder 1 instantly in the mouth of the balloon 5 after the balloon 5 is inflated up, and then tightens the junction between the cylinder 1 and the mouth of the balloon. Thus, the balloon bulb in accordance with the present invention is also formed.

While we have shown and described the embodiment in accordance with the present invention, it should be clear to those skilled in the art that further embodiments may be made without departing from the scope of the present invention.

1. A balloon bulb, comprising a cylinder, in a top surface of which a bulb is inserted, a lower portion of the cylinder is hollow and an inner periphery of which is formed with threads for meshing with a knob, a middle inner space of the cylinder partitioned into a lower space and an upper space by a spacer, the upper space serving to receive a negative and a positive terminal of the bulb, the negative terminal inserted through the spacer so as to be connected to negative pole of a battery below the spacer, the positive terminal connected with a resistor, and then connected to a metal ring after inserting through the spacer;
wherein an upper and a lower battery is disposed below the spacer, the upper battery is wrapped with a thermoplastic sleeve and then a metal spring is used to wrap the two batteries, and finally the two batteries are wrapped with another thermoplastic sleeve again, the metal spring uses a lower end to wind around a metal housing (positive pole) of the lower battery, and an upper end of the spring can contact the metal ring, thus, the positive terminals can contact the positive pole of the lower battery;
the knob is provided at a top surface with a protrusion, when rotating to tighten the knob, the protrusion will push the lower battery upward, so as to make the negative pole of the upper battery abut closely against the negative terminal and make the upper end of the metal spring abut closely against the metal ring, thus, the bulb will light;
if the knob is loosened, elastic force of the metal spring will enforce the negative pole of the upper battery to disconnect from the negative terminal, such that the bulb will not light.

2. The balloon bulb as claimed in claim 1, wherein the cylinder above the spacer is formed on sidewall with plural apertures, the spacer is formed with plural apertures, and the knob is also formed at the top surface with plural apertures, when the user blows through a lower hollow space of the knob with his mouth, air will be blown out through the respective apertures, an outer peripheral surface of the cylinder is covered with a layer of elastic rubber skin which closely covers the apertures on the sidewall of the cylinder when the knob is not inflated, when the user blows through the knob, air will be blown out through the respective apertures and pushes the elastic rubber skin open to leak air.

3. The balloon bulb as claimed in claim 1, wherein the bulb is LED (light emitting diode).

4. The balloon bulb as claimed in claim 2, wherein the bulb is LED (light emitting diode).
